(19) United States
(12) Patent Application Publication
(10) Pub. No.: US 2023/0240814 A1
(43) Pub. Date: Aug. 3, 2023

(54) TISSUE FORMER FOR DENTAL IMPLANTS

(71) Applicant: DRNJAD, LLC, Jacksonville, FL (US)

(72) Inventors: Daniel NOORTHOEK, Boca Raton, FL (US); Gadiel Machuca MEJIAS, Jacksonville, FL (US)

(73) Assignee: DRNJAD, LLC, Jacksonville, FL (US)

(21) Appl. No.: 17/766,438

(22) PCT Filed: Oct. 2, 2020
(86) PCT No.: PCT/US20/53990

§ 371 Date: Apr. 4, 2022

Related U.S. Application Data
(60) Provisional application No. 62/909,366, filed on Oct. 2, 2019.

(51) Int. Cl. A61C 8/00; B33Y 80/00

(52) U.S. Cl. CPC A61C 8/008; B33Y 80/00; A61C 2201/00

(57) ABSTRACT

An example tissue former configured to couple to a dental implant is described herein. The tissue former can include a base portion arranged at a first end of the tissue former, a cap portion arranged at a second end of the tissue former, and a shoulder portion arranged between the base and cap portions. The first and second ends are opposite ends of the tissue former. The tissue former can also include a concave conical portion extending between the base and shoulder portions.

### CROSS-REFERENCE TO RELATED APPLICATIONS

This application claims the benefit of U.S. provisional patent application No. 62/909,366, filed on Oct. 2, 2019, and entitled “TISSUE FORMER FOR DENTAL IMPLANTS,” the disclosure of which is expressly incorporated herein by reference in its entirety.

### BACKGROUND

Conventional multi-unit abutments and their associated healing caps are purpose driven. In particular, abutments and healing caps are designed such that the surgeon is able to locate them and, if necessary, use a surgical instrument (i.e. invasive) to remove/reform unwanted mucosal tissue around the implant sites. Additionally, conventional multi-unit healing caps typically have a cylindrical cone shape (e.g., see FIG. 5).

### SUMMARY

An example tissue former configured to couple to a dental implant is described herein. The tissue former can include a base portion arranged at a first end of the tissue former, a cap portion arranged at a second end of the tissue former, and a shoulder portion arranged between the base and cap portions. The first and second ends are opposite ends of the tissue former. In some implementations, the base portion is configured to abut with an abutment associated with the dental implant. The tissue former can also include a concave conical portion extending between the base and shoulder portions.

Additionally, the base portion is configured to abut with an abutment associated with the dental implant.

Alternatively or additionally, a diameter of the shoulder portion is greater than a diameter of the base portion.

Alternatively or additionally, the concave conical portion defines a curved surface. Optionally, a curvature of the curved surface varies continuously between the base portion and the shoulder portion.

Optionally, a diameter of the shoulder portion is about 6.8 millimeters (mm). Optionally, a diameter of the shoulder portion is about 7.6 mm. Optionally, a diameter of the shoulder portion is about 8.2 mm.

Alternatively or additionally, a curvature of a surface of the concave conical portion is dependent on the diameter of the shoulder portion. For example, a slope of the curvature of the surface of the concave conical portion is variable between the base portion and the shoulder portion. In some implementations, the slope of the curvature of the surface of the concave conical portion is steepest in proximity to the base portion. In some implementations, the slope of the curvature of the concave conical portion is gentlest in proximity to the shoulder portion.

Alternatively or additionally, the tissue former further includes a cavity extending internally between the base and cap portions, wherein the cavity includes a cylindrical portion and a conical portion. Optionally, the conical portion includes a step portion, where the step portion is tapered at an angle of about 120 degrees.

Alternatively or additionally, the cap portion defines a rounded surface.

Alternatively or additionally, the tissue former is coupled to the dental implant with a fastener. Optionally, the dental implant is part of a multi-unit dental system.

Alternatively or additionally, the tissue former is made from a biocompatible material. Optionally, the biocompatible material is printed using a three-dimensional (3D) printer.

Alternatively or additionally, the shoulder portion is shaped to provide a smooth transition between the base portion and the concave conical portion.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates example dental implants and an example dental prosthesis.

FIG. 2 illustrates a tissue former according to an implementation described herein.

FIG. 3 illustrates another view of the tissue former according to an implementation described herein.

FIGS. 4A-4B illustrate other views of the tissue former according to an implementation described herein. FIG. 4A illustrates a minable tissue former. FIG. 4B illustrates a 3D printable tissue former.

FIG. 5 illustrates conventional healing caps installed on dental implants of a patient.

FIG. 6 illustrates the tissue formers according to an implementation described herein installed on dental implants of a patient before the surgeon performed stitching.

FIG. 7 illustrates the tissue formers of FIG. 6 after the surgeon completed stitching.

FIG. 8 illustrates the tissue formers of FIGS. 6 and 7 during healing process.

FIG. 9 illustrates the patient's mouth after the tissue formers of FIG. 8 have been removed.

FIG. 10 illustrates an example tissue former coupled to a dental implant via an abutment.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” or “approximately”, when used in reference to a linear dimension such as “diameter” or an angle mean within plus or minus 10 percentage of the referenced linear dimension or angle.

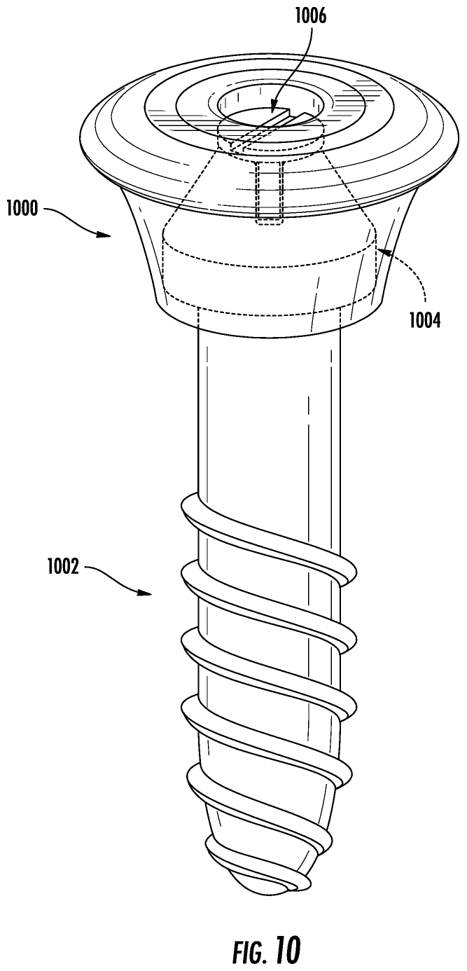

Described herein are tissue formers for dental implants. Tissue formers are configured to contour mucosal tissue around the implant site and/or preserve the shape of mucosal tissue until delivery of a dental prosthesis such as a bridge or crown. In the examples below, the tissue formers are attached to dental implants via multi-unit abutments (e.g., a set including a plurality of abutments). FIG. 10 illustrates a tissue former 1000 coupled to a dental implant 1002 via an abutment 1004. The tissue former 1000 is coupled to the implant 1002 using a fastener 1006. In some implementations, the multi-unit abutments are angled multi-unit abutments. The multi-unit abutments couple to both the implants and the framework of a dental prosthesis such as a bridge (e.g., prosthesis including prosthetic teeth and gingiva). Example dental implants and abutments (including multi-unit abutments) are NEODENT implants and abutments from Straumann Group of Basel, Switzerland. It should be understood that these are only examples. This disclosure contemplates that the tissue formers described herein are not limited for use with multi-unit abutments. For example, the tissue formers described herein can be used with a crown (i.e., a single unit).

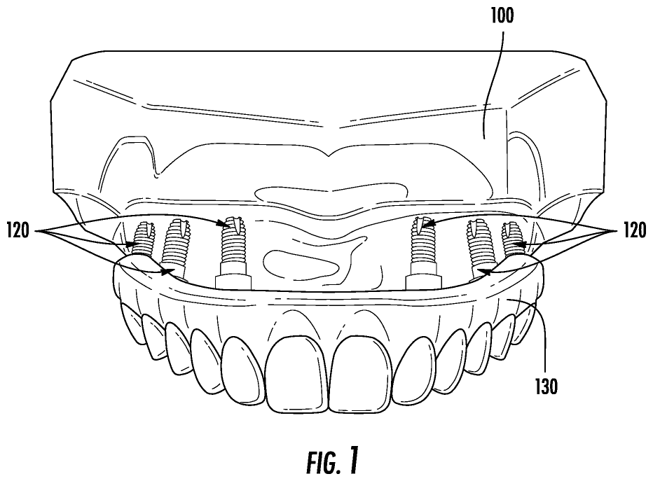

Referring now to FIG. 1, a diagram illustrating implants and a dental prosthesis is shown. During surgery, a surgeon places a plurality of implants 120 in at least one of the patient's upper arch or lower arch. For example, six implants can be placed during surgery. It should be understood that more or less than six implants can be placed during surgery. The implants 120 are embedded in bone, e.g., the patient's maxilla (upper jaw) or mandible (lower jaw). In FIG. 1, the patient's upper jaw is represented by a model 100 made of clear material to show the implants 120 embedded therein. In some cases, the surgeon places implants 120 in only one of the upper arch or lower arch (e.g., FIG. 1). In other cases, the surgeon places implants 120 in both upper and lower arches. In either case, a plurality of implants 120 are placed in the upper arch or the lower arch in the examples below, and a multi-unit abutment is used to couple the implants 120 and the dental prosthesis 130. In other words, the dental prosthesis 130, which is a custom-designed bridge in FIG. 1, is coupled to the implants 120 via a plurality of abutments (not shown) (i.e., multi-unit abutment).

An abutment is configured to secure to both a dental implant and a prosthetic device (e.g., crown, bridge, etc.). An abutment couples with the dental implant (e.g., implant 120 in FIG. 1) on one end and the prosthetic device (e.g., dental prosthesis 130) on the opposite end. For example, in some implementations, the abutment can include an externally threaded portion configured to engage with the dental implant (e.g., implant 120 in FIG. 1) on one end and an internally threaded portion configured to engage with the prosthetic device (e.g., dental prosthesis 130) on the opposite end. Abutments, including multi-unit abutments, are known in the art are therefore not described in further detail herein. For example, a multi-unit abutment is described in U.S. 2018/0325633 to Sarig, published Nov. 15, 2018, titled “Abutment, coping and method of connecting thereof in a dental multi-unit system.”

As discussed herein, tissue formers are installed on the implants (e.g., via an abutment) until delivery of the dental prosthesis. Tissue formers can be used to prevent the gingiva from growing over the dental implants (e.g., dental implants 120 in FIG. 1). The tissue formers described herein are different from conventional healing caps at least because the tissue formers include a concave conical portion. The concave conical portion promotes healing. For example, the concave conical portion presents an emergence profile to the surrounding implant site mucosal tissue that requires no fitting adjustment to the intaglio surface, which guarantees a noninvasive delivery procedure.

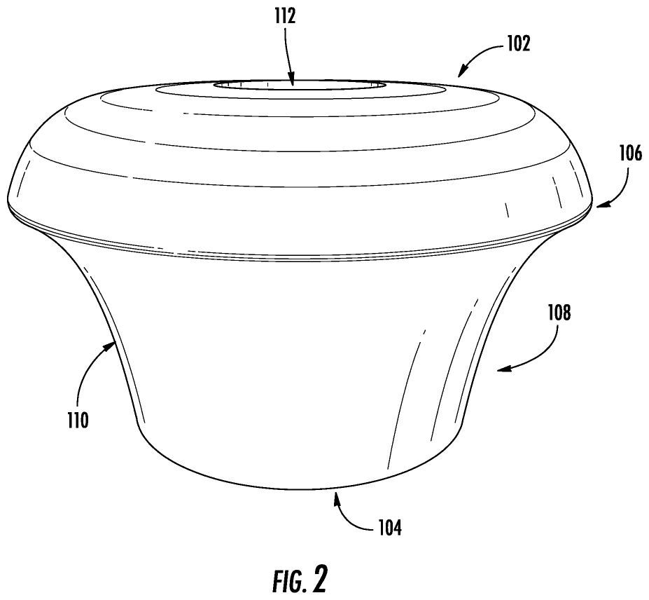

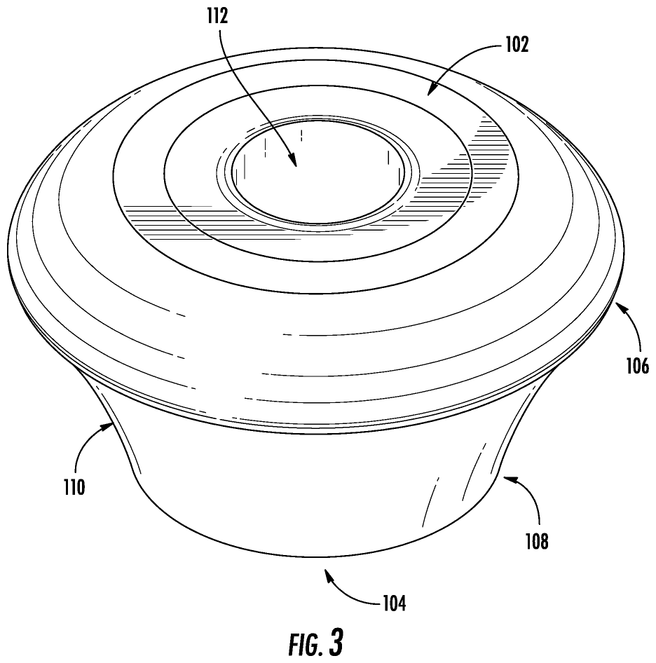

Referring now to FIGS. 2-4B, an example tissue former is described. The tissue former can include a base portion 104 arranged at a first end of the tissue former, a cap portion 102 arranged opposite to the base portion 104 at a second end of the tissue former, and a shoulder portion 106 arranged between the cap portion 102 and base portion 104. The cap portion 102 can define a rounded surface, which helps distribute forces (e.g., forces exerted by chewing) in the patient's mouth. Additionally, the tissue former can be configured to couple to a dental implant (e.g., dental implant 120 in FIG. 1), for example, using a fastener such as a screw (see e.g., FIG. 10). In some implementations, the base portion 104 can abut with an abutment associated with the dental implant (e.g., dental implant 120 in FIG. 1). In other words, the base portion 104 serves as the margin of the abutment. The tissue former can also include a concave conical portion 108 extending between the base and shoulder portions. The shoulder portion 106 is shaped to provide a smooth transition between the base portion 102 and the concave conical portion 108. In this way, the tissue former lacks a lip or projecting edge (see e.g., FIGS. 2-4B). The lack of a lip or projecting edge reduces bacterial infection in a patient during the healing process. The tissue former can optionally be made from a biocompatible material. This disclosure contemplates that the tissue formers described herein can be manufactured by milling or three-dimensional (3D) printing. Milling and 3D printing processes are known in the art and are therefore not described in further detail herein.

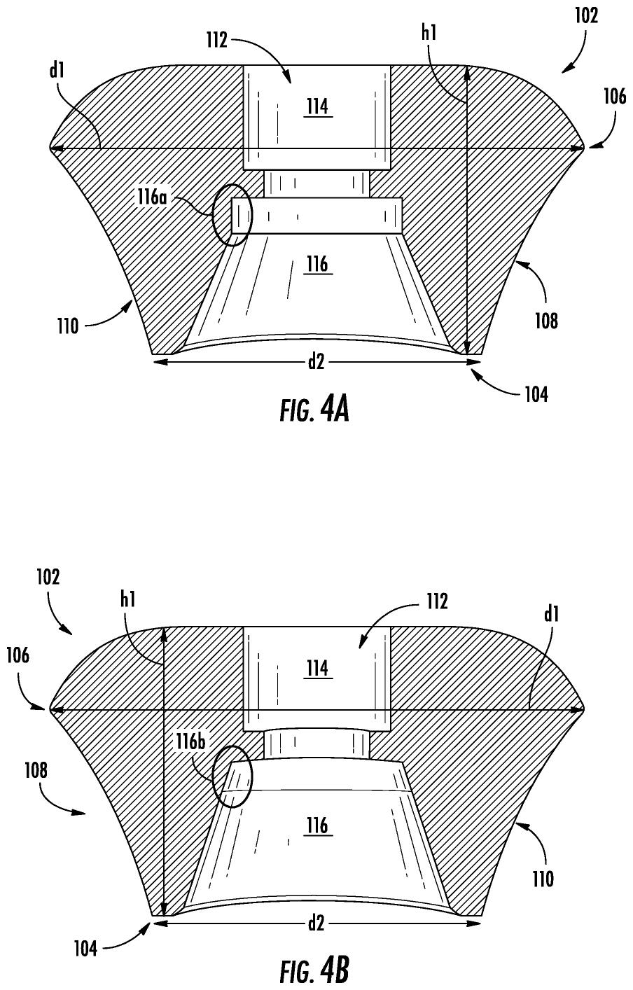

A diameter d1 of the shoulder portion 106 can be greater than a diameter d2 of the base portion 104. Diameter d1 is the largest diameter region of the tissue former. In some implementations, as shown in FIGS. 4A and 4B, the diameter d1 of the shoulder portion 106 can be about 7.6 millimeters (mm). In other implementations, the diameter d1 of the shoulder portion 106 can be less than 7.6 mm, for example, about 6.8 mm. In yet other implementations, the diameter d1 of the shoulder portion 106 can be greater than 7.6 mm, for example, about 8.2 mm. It should be understood that the diameters above (e.g., 6.8, 7.6, and 8.2 mm) are provided only as examples. This disclosure contemplates that the diameter d1 of the shoulder portion 106 can have a different diameter than those provided as examples. Additionally, as shown in FIGS. 4A and 4B, a height h1 of the tissue former can be about 4.5 mm. It should be understood that the height above (e.g., 4.5 mm) is provided only as an example. This disclosure contemplates that the height h1 can be more or less than 4.5 mm.

The tissue former described herein facilitates healing by way of the concave conical portion 108. For example, the concave conical portion 108 is configured to seat the patient's gum tissue down against the tissue former. This is accomplished by the curved surface of the concave conical portion 108, which is different than a conventional healing cap having a cylindrical or inverted cone shape. Additionally, the tissue former lacks a lip or projecting edge (e.g., beveled edge, sharp edge), which reduces the chances of bacterial infection during the healing process. As shown in FIGS. 2-4B, the concave conical portion 108 defines a curved exterior surface 110. The curvature of the surface 110 of the concave conical portion 108 is dependent on the diameter d1 of the shoulder portion 106. Optionally, a slope of the curvature of the surface 110 gradually varies between the base portion 104 and the shoulder portion 106. For example, the slope of the curvature of the surface 110 is steepest in proximity to the base portion 104, and the slope of the curvature of the surface 110 is gentlest in proximity to the shoulder portion 106. This design facilitates seating the patient's gum tissue down against the tissue former.

The tissue former can further include a cavity 112 extending internally between the base and cap portions, where the cavity 112 includes a cylindrical portion 114 and a conical portion 116. As shown in FIG. 4B, the conical portion 116 of the cavity 112 can include a step portion 116b (also enclosed by oval in FIG. 4B), where the step portion 116b is tapered at an angle of about 120 degrees. This is in comparison to the step portion 116a in FIG. 4A (also enclosed by oval in FIG. 4A), which is at a 90 degree angle. Providing the step portion 116b with tapered 120 degree angle facilitates the ability to manufacture the tissue former using a 3D printer. Material limits and/or 3D printing tolerances make manufacture of a 90 degree step portion difficult.

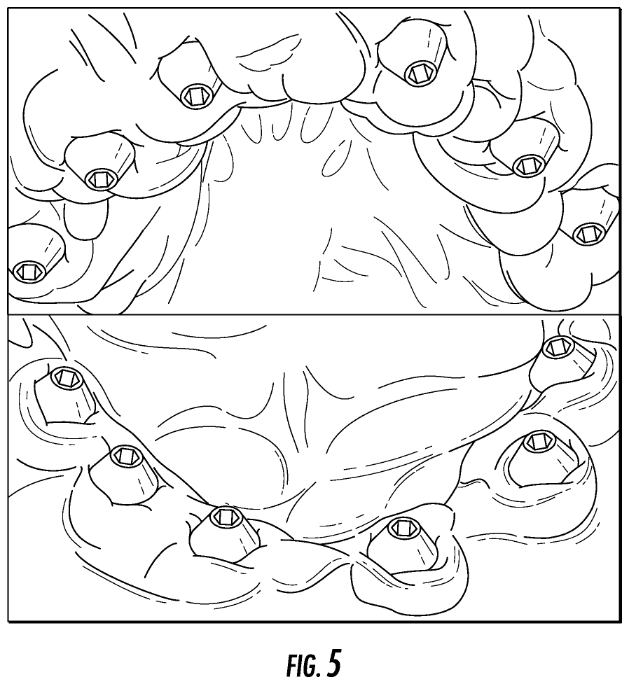

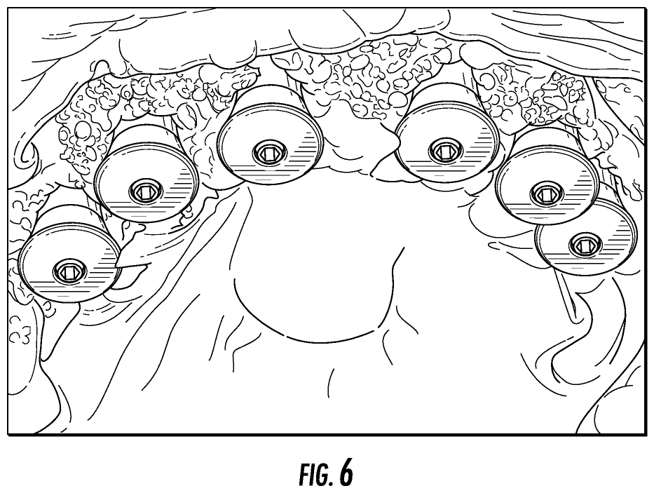

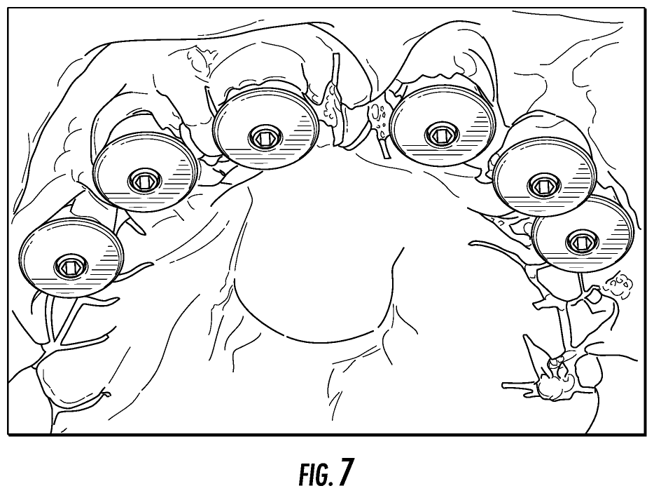

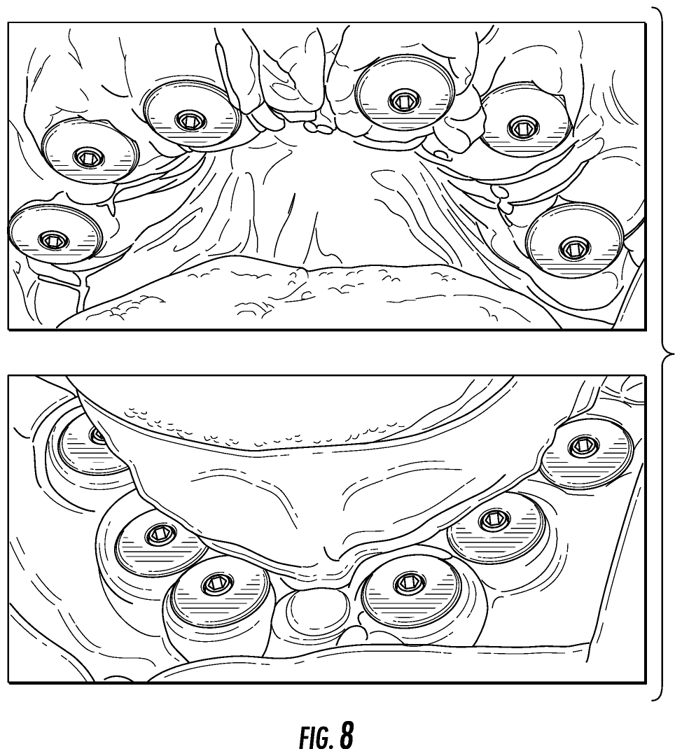

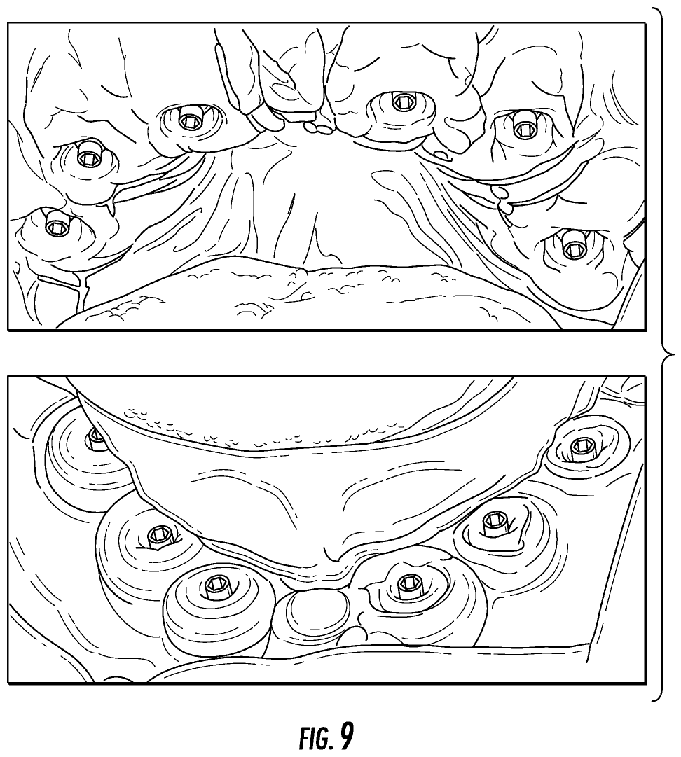

FIG. 5-9 are provided to compare conventional healing caps with the tissue formers described herein. FIG. 5 illustrates conventional healing caps installed on dental implants of a patient. FIG. 6 illustrates the tissue formers described herein (e.g., see FIGS. 2-4B) installed on dental implants of a patient before the surgeon performed stitching. FIG. 7 illustrates the tissue formers of FIG. 6 after the surgeon completed stitching. FIG. 8 illustrates the tissue formers of FIGS. 6 and 7 during healing process. FIG. 9 illustrates the patient's mouth after the tissue formers of FIG. 8 have been removed. The dental implants are visible in FIG. 9. As shown in FIG. 9, the tissue formers described herein have contoured mucosal tissue around the implant site and preserved the shape of mucosal tissue. As a result, the surgeon can install the dental prosthesis (e.g., dental prosthesis 130 in FIG. 1) using a noninvasive procedure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A tissue former configured to couple to a dental implant, comprising:
a base portion arranged at a first end of the tissue former;
a cap portion arranged at a second end of the tissue former, the first and second ends being opposite ends of the tissue former;
a shoulder portion arranged between the base and cap portions; and
a concave conical portion extending between the base and shoulder portions.

2. The tissue former of claim 1, wherein the base portion is configured to abut with an abutment associated with the dental implant.

3. The tissue former of claim 1, wherein a diameter of the shoulder portion is greater than a diameter of the base portion.

4. The tissue former of claim 1, wherein the concave conical portion defines a curved surface.

5. The tissue former of claim 4, wherein a curvature of the curved surface varies continuously between the base portion and the shoulder portion.

6. The tissue former of claim 1, wherein a diameter of the shoulder portion is about 6.8 millimeters (mm).

7. The tissue former of claim 1, wherein a diameter of the shoulder portion is about 7.6 mm.

8. The tissue former of claim 1, wherein a diameter of the shoulder portion is about 8.2 mm.

9. The tissue former of claim 6, wherein a curvature of a surface of the concave conical portion is dependent on the diameter of the shoulder portion.

10. The tissue former of claim 9, wherein a slope of the curvature of the surface of the concave conical portion is variable between the base portion and the shoulder portion.

11. The tissue former of claim 10, wherein the slope of the curvature of the surface of the concave conical portion is steepest in proximity to the base portion.

12. The tissue former of claim 10, wherein the slope of the curvature of the concave conical portion is gentlest in proximity to the shoulder portion.

13. The tissue former of claim 1, further comprising a cavity extending internally between the base and cap portions, wherein the cavity includes a cylindrical portion and a conical portion.

14. The tissue former of claim 13, wherein the conical portion comprises a step portion, wherein the step portion is tapered at an angle of about 120 degrees.

15. The tissue former of claim 1, wherein the cap portion defines a rounded surface.

16. The tissue former of claim 1, wherein the tissue former is coupled to the dental implant with a fastener.

17. The tissue former of claim 16, wherein the dental implant is part of a multi-unit dental system.

18. The tissue former of claim 1, wherein the tissue former is made from a biocompatible material.

19. The tissue former of claim 18, wherein the biocompatible material is printed using a three-dimensional (3D) printer.

20. The tissue former of claim 1, wherein the shoulder portion is shaped to provide a smooth transition between the base portion and the concave conical portion.
